(19) United States
(12) Patent Application Publication
(10) Pub. No.: US 2011/0296294 A1
(43) Pub. Date: Dec. 1, 2011

(54) Advertising and Mobile Site Builder

(76) Inventors: Roop Kumar Bhadury, Eastern Heights (AU); Mark BROWN, Eastern Heights (AU); Derek MCDONALD, Jimboomba (AU); Dev Mayur ZAVERI, Robertson (AU)

(21) Appl. No.: 13/117,095

(22) Filed: May 26, 2011

Related U.S. Application Data
(60) Provisional application No. 61/348,560, filed on May 26, 2010.

(51) Int. Cl. G06F 17/20

(52) U.S. Cl. 715/234

(57) ABSTRACT

A content builder creates content for a layered panel on a web page, using pre-configured templates as building blocks for the content. The layered panel is created using a template wherein the template is selected from a plurality of templates and the layered panel created is a micro-website, or content for a mobile device. The micro-website resides on a storage device attached to an online delivery network. The layered panel is assembled contemporaneously with delivery of the panel.

### PRIORITY

This application claims the benefit of U.S. provisional application 61/348,560, filed on May 26, 2010, the entire contents of which are incorporated herein by reference.

### FIELD

The field of the invention relates generally to computer systems. In particular, a preferred embodiment of the invention is directed to generating content using a template driven approach to data representation, that can be served in an active web panel within a web page.

### BACKGROUND

Historically, applications that serve web page advertisements to users are downloaded and included as data within a web page. This method adds extra data to load onto a user device causing delays and adding undesirable “weight” to the web page. Moreover, this type of application can be very limited in interactivity and functionality.

In online advertising the user is often neglected. The current trend is to deliver numerous banner ads, text based ads, rich content and the like without necessarily attempting to understand what the end user actually wants.

This results in ads trying to force or deceive the user into clicking on something that the user may not have normally clicked on. Users have responded to these tactics by practically ignoring online ads, with global CTR (Click-through rates) hovering around 0.10%.

Therefore, what is needed and what the present application addresses is an advertisement panel and a system and method for building the panel that is itself an interactive webpage that is called by the host web page reducing the host webpage “weight” while allowing increased interactivity and functionality.

### SUMMARY

A system and method is disclosed comprising a builder which allows for the development of advertisement and content that can be served in a user viewable web panel, such as a layered panel in an HTML host web page, by using a wizard with a template driven approach to data representation. The layered panel is created using a template in which the template is selected from a plurality of templates and the layered panel created is a micro-website. The micro-website resides on a storage device connected to an online delivery network. Customers can select from one of many available configurable templates as a starting point. Using a simple point and click interface or API driven scripts, one can create micro-web and mobile viewable websites that span multiple pages of content. The created content can be saved as a custom template and used at a later point in time. The builder can create types of content which include but are not limited to text, images, video and interactive elements like forms and surveys. In an embodiment, the builder comprises a micro-web and mobile content builder. In another embodiment, the builder comprises a form and survey builder.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates an exemplary flow diagram of a method of building a website according to an embodiment of the invention.

FIG. 2 illustrates an exemplary flow diagram of a method of building a survey page for a website according to an embodiment of the invention.

FIG. 3 illustrates an exemplary panel builder tool according to an embodiment of the invention.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION OF THE PREFERRED EMBODIMENTS

The present application is related to U.S. patent application entitled “End User Viewable Web Element” by Roop Kumar Bhadury and Dev Mayur Zaveri, filed on May 26, 2011; U.S. patent application entitled “Content and Application Serving Mechanism” by Roop Kumar Bhadury, Derek McDonald, and Dev Mayur Zaveri, filed on May 26, 2011; and U.S. patent application entitled “User Account Linking” by Roop Kumar Bhadury, Derek McDonald, and Dev Mayur Zaveri, filed on May 26, 2011, the entire contents of which are incorporated herein by reference.

As set forth in further detail in the related application, titled “End-User Viewable Web Element”, filed on the same date as the present application and incorporated herein by reference, a user viewable element is displayed to a user in an unused area in a web browser. This element is advantageously placed within a panel, or a container, on the web browser. The element is displayed alongside user-requested web content. This allows the element to persist across multiple pages requested by the user, thus promoting a consistent or seamless viewing experience for the element.

According to one embodiment, the panel described in the related application is a panel which is added to a page by inserting a snippet of code in the HEAD section of the HTML in a page. Nothing other than the web page itself is installed on the web servers of the publisher of the advertisement and there is nothing other than the actual web page and panel content to be downloaded or installed in the browser of the end user. Thus, the method and system have the advantage of not consuming space on either the publisher's server or the end user's browser.

As discussed in the related application, the panel may be instantiated within a container that itself encapsulates multiple different web pages, creating a seamless experience where the panel persists as the web-page content changes. This creates a “micro-website” within the container. Additionally, once the website or micro-website is created, the user can select a different theme template to entirely change the micro-website appearance. The specific details of the template appearance and site design are design choices for the builder of the site, and are not critical to the preferred embodiments of the invention. This template-based reconfiguration is achieved by applying the saved data and user preferences to the new template.

According to an embodiment, the panel disclosed in the related application is created using a panel builder tool that applies a template-driven approach. By using a template approach, the builder tool reduces the time required for the creation of the website. The user uses a template to design the website, and then saves that template data as a collection of data elements in a database, and any user preferences that have been applied to customize the data elements. Additionally, the user may create new content, which content is saved in the database as a new template. All newly created designs and preferences can be stored as templates for future use. Users can create multiple pages of content and specify different types of input data for each page. The input data categories include but are not limited to text, images and video. Once a template (packaged or custom created) is selected, users can start specifying data to be applied to that template, which data is then stored in folders on the content delivery network, or alternatively in the database.

.Users specify the look of the micro web page or micro-website and all preferences are then stored in an online database in the delivery network. The micro-website is configured using a combination of layout, icon, color and theme/template options. Users can opt for the theme driven builder or a more advanced builder that allows for theme creation using ‘drag and drop’ elements.

In a preferred embodiment, the micro-websites are stored as a function of their component parts and not as the website itself. This reduces the data overhead when these websites are served out as ads or content. When multiple micro-websites containing the same data element need to be served, they are able to refer to the same location on the content delivery network to render content. Data could be used for more than one micro-website, requiring the user to specify it only once. The micro-website is preferably put together dynamically ‘on-the-fly’ during a campaign, an displayed to the user. Alternatively, some or all of the elements of the micro-website may be pre-assembled and stored in the database, to facilitate faster assembly of the panel content and the user-requested web content. The micro-website may be displayed in a variety of formats, for example as a page in a standard browser such as Internet Explorer, Firefox, or Chrome. Alternatively, the micro-website may be displayed as mobile content, on a mobile device such as a mobile telephone. While each of these formats differs in certain respect from each other, these differences are appreciated by those of skill in the art and are not critical to the invention. Use of the template-driven approach allows a user of the builder tool to design the micro-website once, and then the website can be instantiated in a variety of different formats for display on a variety of different devices.

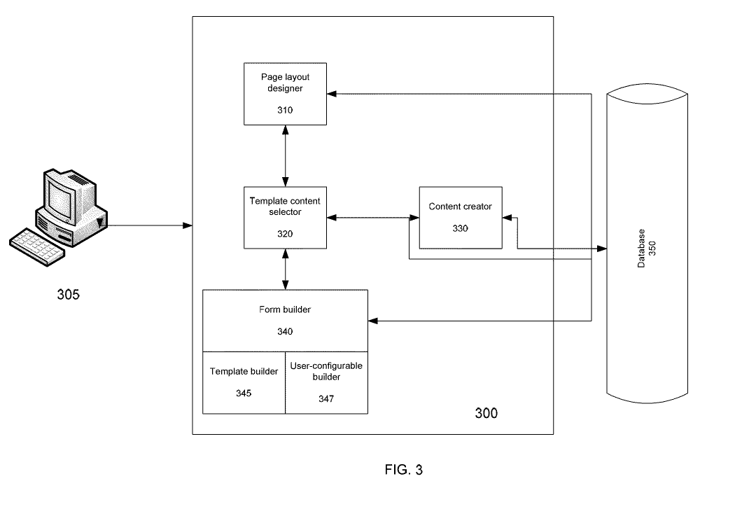

An embodiment of a builder tool is shown in FIG. 3. The builder tool 300 is a software tool resident on a computer 305. The computer 305 is accessed by a designer wishing to build a panel according to embodiments of the invention as discussed herein. The builder tool 300 comprises a page layout designer 310, which accepts user inputs from the computer 305, indicating how the page layout will appear, and uses these inputs to set up the layout of the page. For example, the page layout designer 310 can configure a general theme for the panel, or for the micro-website containing the panel. The page layout designer 310 can also configure the location on the panel or web page of items such as a logo, buttons, links to other pages, and content items within the panel or web page. The builder tool 300 also includes a template content selector 320. The template content selector 320 receives input from the designer using the computer 305, and responds by selecting template content from a variety of sources. The template content may be stored in the database 350, in which case the template content selector 320 retrieves the content from the database 350. Alternatively, the template content may be supplied by the designer from an external source. Thus, where the template content is an image or video content, the image/video may be uploaded into the panel being created by the builder tool 300. If the template content is text, the text may be entered by the designer, or retrieved from another document. Where the template content is a form or survey, the template content selector may permit the designer to configure the form values and variables, or the survey data, or may upload those values, variables and data from the database 350, or from some external source.

The builder tool 300 further contains a content creator module 330. This content creator module contains design tools that allow the designer to build up a panel according to the designer's preferences, rather than being constrained by the choices of available template building blocks accessible to the template content selector 320. Any panels created using the content creator module 330 may be stored to the database 350 for later use as templates.

The builder tool 300 further includes a form builder 340, which is adapted to create forms for use in the panel. The form builder 340 includes a form template selector 345, which allows the designer to select a template for the form, either from the database 350 or from some other source, and then populate the form template with appropriate values in a manner similar to the use of the template content selector 320 above. The form builder 340 further include s a user-configurable form builder 347, which allows the designer to create his/her own forms. The user-configurable form builder 347 then saves these user-created forms to the database 350.

According to an embodiment, the builder tool 300 contains a drag and drop capability that allows users to create custom theme templates using predefined building blocks that can then be used to define the look of the new template. Once created, these custom themes can be saved as templates for future use. A web store for the sale of such templates to other users is also enabled.

In an embodiment, the builder tool 300 also includes an interactive form and survey builder 340. Forms and surveys can be created using either the template based approach discussed above, or a user configurable approach. According to one embodiment, the user selects from multiple pre-configured form and survey layouts and specifies essential input data such as the username and email address requested from the survey responder, the survey type, the specific survey questions, etc. Similar to the template approach in the micro-website creator, discussed above, the actual visual elements of the form or survey and the input fields are separately stored on a database 350. This allows for a straightforward template change since these forms and surveys are also put together, in an embodiment, ‘on-the-fly’ during an advertising campaign. It is important to note here that both these interactive elements (forms and surveys) appear as a part of micro-website content, or alternatively as part of mobile content, as discussed above.

According to another embodiment, users are able to specify form or survey elements such as the number of input fields to appear on the form or survey, the number of questions, the nature of the expected responses, sample responses, or even a list of responses from which the survey responder can select, etc. and then specify input data accordingly. The visual appearance, user preferences, and user data are separately stored on the delivery network, allowing for dynamic creation and delivery of these forms and surveys.

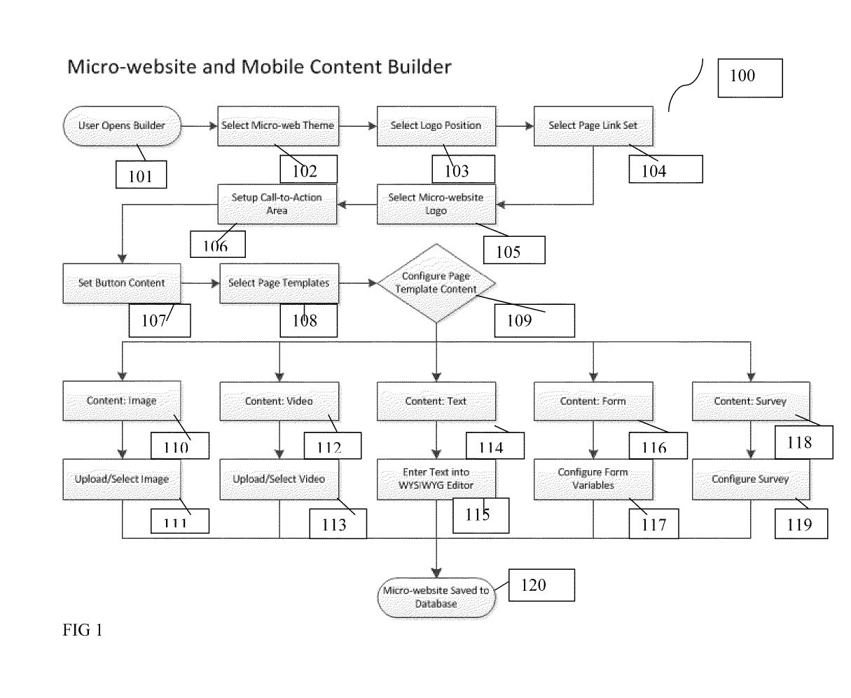

Referring to flowchart 100 in FIG. 1, the following describes a process to create the panel, according to an embodiment of the invention. The designer opens the builder tool at step 101 and selects a micro-website theme at step 102. The designer also selects a logo position, for locating a desired logo on the panel, at step 103, and selects a desired set of page links, at step 104. These page link sets may be, for example, a set of pre-defined page links that the designer wishes to apply to the panel being created. At step 105, the designer selects a particular logo the designer wishes to appear on the micro-website, at the location selected in step 103. At step 106, the designer selects an action area (such as a call-to-action section) of the panel. The designer then sets the button content at step 107, to describe the particular buttons the designer wishes to implement in the panel, to collect user input. The designer then selects from various page templates at step 108 and configures the page content within the selected page templates at step 109, from various options. These options include image content (step 110), video content (step 112), text content (step 114), forms (step 116) and survey forms (step 118). The user uploads the content for images (step 111), video, (step 113), text (step 115), configures form variables (step 117) and survey variables (step 119). The user then saves the micro-website to the delivery network database, at step 120.

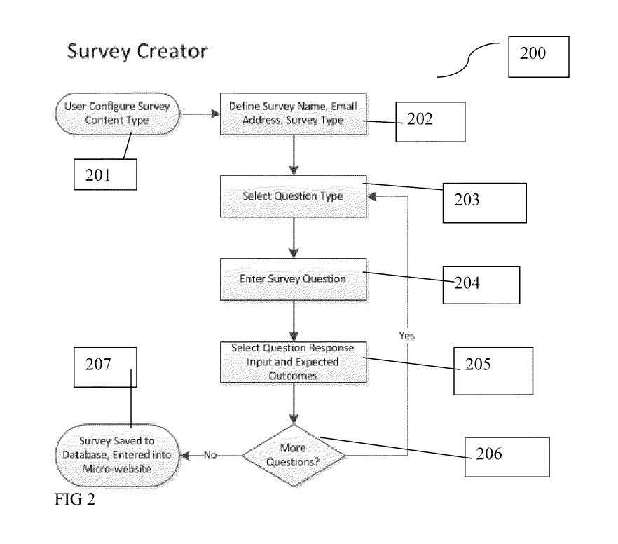

Referring to flow diagram 200 in FIG. 2, an embodiment of a process for creating a survey is disclosed. The user configures the desired survey content type at step 201. Here, the user may either select from a library of survey content types stored in the template layouts, or may design his/her own survey content type. The user then defines the survey name, email address and survey type at step 202. The question types to be included in the survey are then selected at step 203 and the first survey question itself is entered into the survey template at step 204. The user then adds a question response input area and an expected outcome for the question, at step 205. The user decides if more questions are desired in the survey at step 206, and if so returns to the question type selection step (203) and adds more questions following the steps above. Once complete the survey is saved into the database and entered into the micro-website, at step 207.

Each of the features and teachings disclosed herein can be utilized separately or in conjunction with other features and teachings to provide a method and system for providing asynchronous data communication in a networked environment. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the foregoing description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The various features of the representative examples and the claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

1. A software-implemented builder tool comprising:
A page layout designer module, configured to receive a first user input and present a page layout in response to the first user input;
A template content selector module, configured to receive a second user input and place a content item for a template in the page layout, in response to the second user input; and
A database for storing the page layout and the content item.

2. The tool of claim 1, further comprising a form builder, configured to receive a third user input and present a form in response to the third user input.

3. The tool of claim 2, wherein the form builder comprises a form template builder, configured to present a form template in response to the third user input.

4. The tool of claim 2, wherein the form builder comprises a user-configurable builder, configured to present a user-configured form in response to the third user input.

5. The tool of claim 1, further comprising a content creator module, wherein the content creator module is configured to receive a fourth user input, and present created content in response to the fourth user input.

6. The tool of claim 1, wherein the content item comprises one or more of an image item, a video item, a text item, a form, or a survey.

7. A method of designing a panel for a web page, comprising:
Designing a layout for the panel;
Selecting a content item for the panel, from a database of stored content items;
Configuring the content item; and
Storing the panel and the content item to the database.

8. The method of claim 7, further comprising; designing a created content item, and storing the created content item in the database, wherein the created content item is made available for subsequent use as a template.

9. The method of claim 7, wherein the panel is adapted to be used simultaneously on a web page and on a mobile device.
